(19) United States
(12) Patent Application Publication
(10) Pub. No.: US 2004/0217550 A1
(43) Pub. Date: Nov. 4, 2004

(54) Piston ring for internal combustion engine and internal combusion engine using the same

(76) Inventor: Tae Kyoung Lee, Hwaseong-city (KR)

Correspondence Address: MORGAN, LEWIS & BOCKIUS LLP (SF), 3300 HILLVIEW AVENUE, PALO ALTO, CA, 94304, US

(21) Appl. No.: 10/857,142

(22) Filed: May 28, 2004

(30) Foreign Application Priority Data
Apr. 11, 2003 (KR) 10-2003-0077686

(51) Int. Cl. F02F 1/00; F16J 9/12

(52) U.S. Cl. 277/459

(57) ABSTRACT

A plurality of slits are formed on an interior circumference of a piston ring, such that a piston ring can be easily mounted to a piston, and a piston ring mounted with such a piston ring may be easily installed in a cylinder. Additionally, such a piston ring maintains contact to an interior wall of a cylinder during cylinder bore deformation.

### CROSS-REFERENCE TO RELATED APPLICATIONS

This application claims priority to Korean Application No. 10-2003-0077686, filed on Nov. 4, 2003, the disclosure of which is incorporated fully here by reference.

### FIELD OF THE INVENTION

Generally, the present invention relates to a piston ring for an internal combustion engine and to an internal combustion engine using the piston ring. More particularly, the piston ring provides contact to an interior wall of a cylinder bore during deformation of the cylinder bore.

### BACKGROUND OF THE INVENTION

It is well known in the art that an internal combustion engine produces power by taking air and fuel into a cylinder and burning the fuel/air mixture therein. A piston is typically disposed in the cylinder such that it reciprocates from combustion pressure produced by combustion of the fuel/air mixture. The piston is provided with a piston ring for both sealing and lubrication between the piston and the wall of the cylinder bore.

During operation of the engine, the cylinder block undergoes thermal expansion. During thermal expansion, the interior wall of the cylinder experiences deformation when the engine is used for a long term. Such deformation includes a first order deformation in which only a radius of a cylinder bore is changed and a complex deformation. The first order deformation implies that the bore of the cylinder is either reduced or expanded. The complex or multiple order deformation of more than a second order accompanies a distortion of a shape of a cylinder cross-section. Such a degree of distortion is measured by the number of crests formed on the interior wall of the cylinder protruding toward the center of the cylinder, or equivalently, by the number of valleys thereon subsiding toward an exterior of the cylinder. Such numbers of crest and valleys is called the order of deformation.

With higher order deformation, an undulation of the deformation becomes greater. In this case, if a piston ring is not flexible enough to follow the undulation of the interior wall of the cylinder, a gap may occur between the piston ring and the interior wall of the cylinder. If such a gap occurs between the piston ring and the interior wall of the cylinder, combustion power of an engine may escape the combustion chamber formed between the top of the piston, ring, cylinder wall, and cylinder head. This escaped combustion is a wasted combustion because the combustion is exhausted to a crankcase through the cylinder wall/ring gap instead of converted to rotational force through movement of the piston. In addition, in such a case, lubricant may leak into a combustion chamber and be burned therein, thus exposing the engine to excessive consumption of lubricant.

FIG. 1 illustrates such crests, valleys, and a gap occurring between a piston ring 130 and an interior wall of a cylinder. When a valley 120 is formed deep between crests 110, elasticity of the piston ring 130 is often not sufficient to enable the piston ring 130 to maintain a tight contact to the cylinder wall in the valley 120.

For better contact of a piston ring with an interior wall of the cylinder against a deformation of a cylinder bore, an elastic coefficient of the piston ring may be increased. However, in this case, friction is increased between the piston ring and the cylinder wall during movement of the piston, and therefore, the interior wall of the cylinder wears rapidly and performance of an engine is reduced.

The information disclosed in this Background of the Invention section is only for enhancement of understanding of the background of the invention, and should not be taken as an acknowledgement or any form of suggestion that this information forms the prior art that is already known in this country to a person of ordinary skill in the art.

### SUMMARY OF THE INVENTION

The present invention provides a piston ring for an internal combustion engine that contacts to an interior wall of a cylinder during a deformation of the cylinder bore. An exemplary internal combustion engine according to an embodiment of the present invention includes a cylinder block having a cylinder, a piston for reciprocating in the cylinder, and a piston ring mounted to the piston for contacting an interior wall of the cylinder.

An exemplary piston ring for an internal combustion engine according to an embodiment of the present invention includes an exterior circumference for contacting to an interior wall of a cylinder, and an interior circumference formed interior to the exterior circumference, wherein a plurality of slits are formed on the interior circumference. In a further embodiment, each slit is open in a direction vertical to the interior circumference of the piston ring. In a yet further embodiment, a length of each slit is generally half of a width of the piston ring. In another further embodiment, the slit is formed across a height of the interior circumference.

According to another embodiment, a total length of the interior circumference excluding the slits is greater than or equal to 2π(R−b2)−G1, wherein R, b2, and G1 respectively denote a radius of the interior wall of the cylinder, the width of the piston ring, and a piston ring gap.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 illustrates crests, valleys, and a gap occurring between a piston ring and an interior wall of a cylinder;

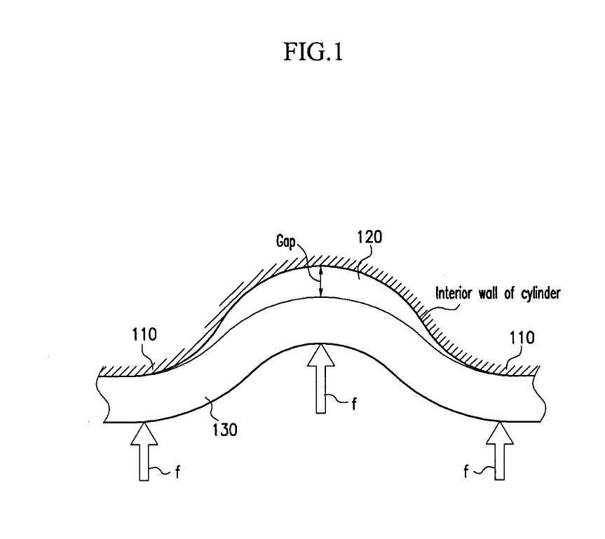

FIG. 2 is a partial cross-sectional perspective view of an internal combustion engine according to an embodiment of the present invention;

FIG. 3 is a perspective view of a piston ring according to an embodiment of the present invention; and

FIG. 4 illustrates a deformation of a piston ring according to an embodiment of the present invention when an engine experiences a deformation of a cylinder bore.

### DETAILED DESCRIPTION OF THE PREFERRED EMBODIMENTS

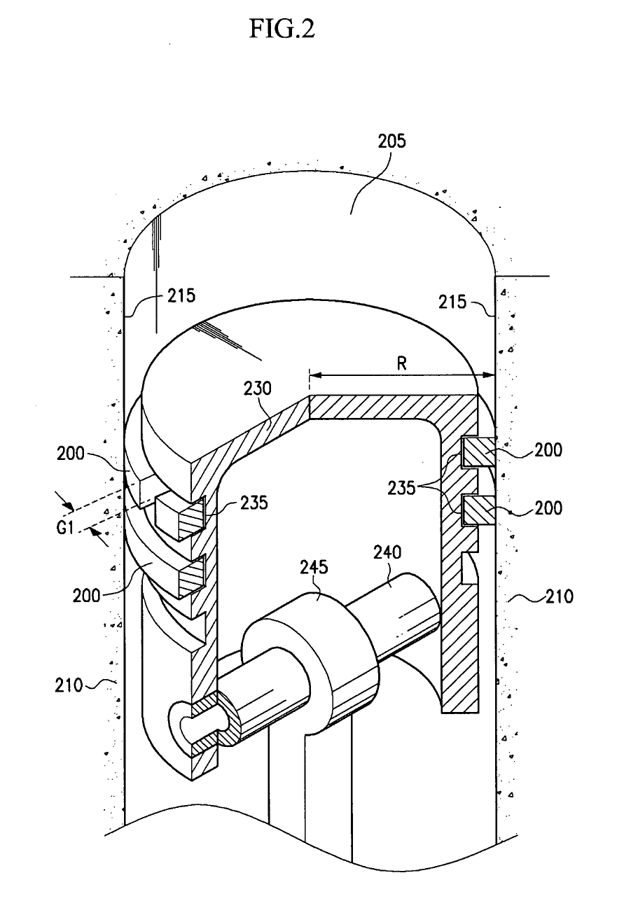

FIG. 2 shows a partial cross-sectional perspective of an internal combustion engine according to an embodiment of the present invention. An internal combustion engine includes a cylinder block 210 having a cylinder 205, a piston 230 for reciprocating in the cylinder 205, and a piston ring 200 mounted to the piston 230 for contacting to an interior wall 215 of the cylinder 205. The piston ring 200 is mounted to a piston ring groove 235 of the piston 230. When the piston 230 mounted with the piston ring 200 is inserted into the cylinder 205, the piston ring 200 forms a piston ring gap G1.

Expansion pressure of combusted fuel in the cylinder is transmitted to the piston 230, which subsequently converts the pressure to a rotational force of a crankshaft through a connecting rod 245 which is connected to the piston 230 by a piston pin 240.

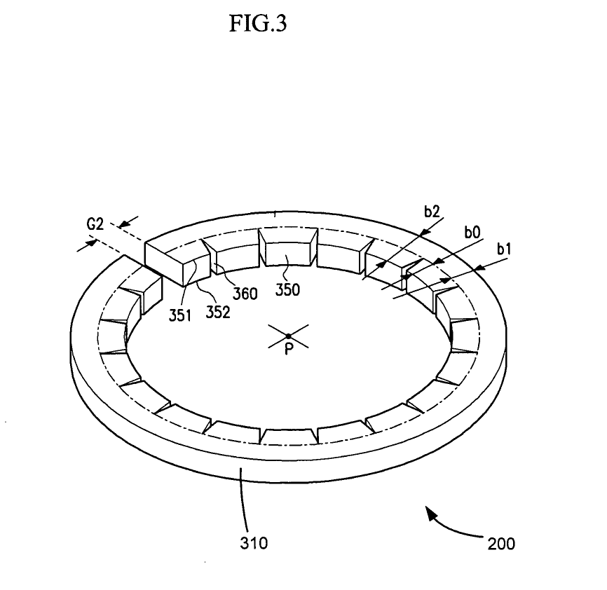

According to FIG. 3, the piston ring 200 includes an exterior circumference 310 for contacting the interior wall 215 of the cylinder 205, and an interior circumference 350 formed interior to the exterior circumference 310 for being mounted to the piston 230. A plurality of slits 360 are formed on the interior circumference 350. The slits 360 have a predetermined length b0 in a radial direction (i.e., in a direction vertical to the interior circumference) of the piston ring 200. The slits 360 are formed from top 351 to bottom 352 of the interior circumference 350.

Before being inserted into the cylinder 205, the piston ring 200 expands by its elasticity, and therefore it forms a piston ring gap G2, which is greater than the piston ring gap G1 formed when the assembled piston and ring combination are inserted into the cylinder 205.

Since a plurality of slits 360 are formed in the piston ring 200, an effective width of the piston ring 200, before being inserted into the cylinder 205, corresponds to a width b1 free from the slits 360. The effective width b1 is smaller than a total width b2 of the piston ring 200. Elasticity of a piston ring is proportional to a cube of an effective width thereof, thus the elasticity of the piston ring 200 is small in such a free state before being inserted into the cylinder 205. Due to the flexibility of the piston ring 200, the piston ring 200 may be easily manipulated to be mounted on the piston 230, and in addition, the piston 230 and piston ring 200 combination may be easily installed in the cylinder 205.

A length b0 of the slit 360 may be preferably set as an optimal value while taking into account a required specification of an engine that uses the piston ring 200. According to an embodiment of the present invention, a length b0 of the slits 360 is preferably formed at about half of the width b2 of the piston ring 200. Therefore, in a free state, the piston ring 200 shows ⅛ the elasticity of a piston ring without such slits 360.

According to an embodiment of the present invention, a length of the interior circumference 350, excluding the slits 360, is formed greater than or equal to 2π(R−b2)−G1. Here, R, b2, and G1 respectively denote a radius of the interior wall of the cylinder, the width of the piston ring, and a piston ring gap. Therefore, when the piston ring 200 is inserted into the cylinder 205, the clearances between the slits 360 is minimized as the radius of the piston ring 200 decreases. While the piston ring 200 is inserted into the cylinder 205, the interior circumference 350 of the piston ring 200 normally becomes continuously connected, and accordingly the effective width of the piston ring 200 becomes the total width b2. Therefore, the interior wall 215 of the cylinder receives elastic force of the piston ring 200 corresponding to the total width b2. As a result the interior wall 215 is in contact with the piston ring 200 according to a predetermined pressure.

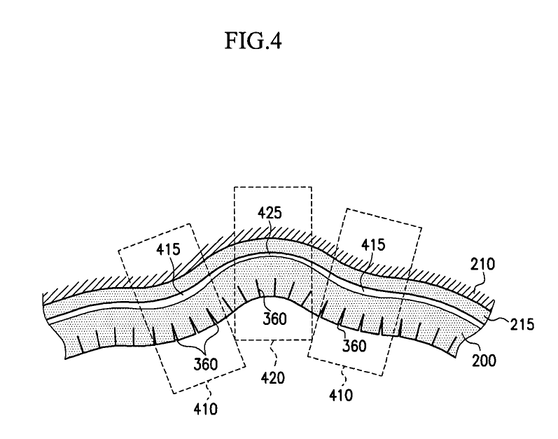

FIG. 4 illustrates a deformation of the piston ring 200 according to an embodiment of the present invention. The piston ring 200 deforms to accommodate a deformation of a cylinder bore of an engine. When a complex undulation is formed on the interior wall 215 of the cylinder 205, as shown in FIG. 4, slits 360 in a crest region 410 become open and accordingly the elastic coefficient of the piston ring 200 is lowered at that point. Therefore, the piston ring 200 may easily bend along the crest 415 of the interior wall 215, and accordingly the piston ring 200 may better contact the interior wall 215 of the cylinder 205 in a valley region 420.

When such a piston ring is inserted in the cylinder, the piston ring normally produces elastic force corresponding to a total width thereof and becomes in tight contact to an interior wall of the cylinder. According to an embodiment of the present invention, even when a high order deformation occurs on the interior wall of the cylinder, good contact to the interior wall of the cylinder remains substantially constant.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A piston ring for an internal combustion engine, comprising:
an exterior circumference for contacting an interior wall of a cylinder of the internal combustion engine; and
an interior circumference formed interior to the exterior circumference,
wherein a plurality of slits are formed on the interior circumference.

2. The piston ring of claim 1, wherein each slit is open in a direction vertical to the interior circumference of the piston ring.

3. The piston ring of claim 2, wherein a length of the slit is generally half of a width of the piston ring.

4. The piston ring of claim 3, wherein a total length of the interior circumference of the piston ring excluding the slits is at least to 2π(R−b2)−G1, wherein R, b2, and G1 respectively denote a radius of the interior wall of the cylinder, the width of the piston ring, and a piston ring gap.

5. The piston ring of claim 1, wherein the slit is formed across a height of the interior circumference.

6. The piston ring of claim 1, wherein a total length of the interior circumference of the piston ring including the slits is greater than or equal to 2π(R−b2)−G1, wherein R, b2, and G1 respectively denote a radius of the interior wall of the cylinder, the width of the piston ring, and a piston ring gap.

7. An internal combustion engine, comprising:
a cylinder block having a cylinder;
a piston for reciprocating in the cylinder; and
a piston ring mounted to the piston for contacting an interior wall of the cylinder,
wherein the piston ring comprises an exterior circumference for contacting the interior wall of the cylinder, and an interior circumference formed interior to the exterior circumference, wherein a plurality of slits are formed on the interior circumference.

8. The piston ring of claim 7, wherein each slit is open in a direction vertical to the interior circumference of the piston ring.

9. The piston ring of claim 8, wherein a length of the slit is generally half of a width of the piston ring.

10. The piston ring of claim 9, wherein a total length of the interior circumference of the piston ring including the slits is at least equal to 2π(R−b2)−G1, wherein R, b2, and G1 respectively denote a radius of the interior wall of the cylinder, the width of the piston ring, and a piston ring gap.

11. The piston ring of claim 7, wherein the slit is formed across a height of the interior circumference.

12. The piston ring of claim 7, wherein a total length of the interior circumference of the piston ring including the slits is at least 2π(R−b2)−G1, wherein R, b2, and G1 respectively denote a radius of the interior wall of the cylinder, the width of the piston ring, and a piston ring gap.

13. A piston ring, comprising:
a ring shaped member defining a central bore;
said ring shaped member having a first end and a second end, said first end and said second end being configured substantially adjacent each other and separated by a predetermined distance range; and
at least one slit extending from an interior surface of said ring shaped member toward an exterior surface of said ring shaped member.

14. The ring of claim 13, further comprising a plurality of slits extending substantially half the distance from the interior surface of said ring shaped member to the exterior surface of said ring shaped member.

15. The ring of claim 13, wherein the slit extends about one-half the distance between the interior surface of the ring and the exterior surface of the ring.

16. The ring of claim 13, wherein said ring shaped member includes;
a first elasticity configured by a thickness of said ring shaped member between an exterior endpoint of said slit and the exterior surface of the ring shaped member; and
a second elasticity configured by a thickness of said ring shaped member between the interior surface and the exterior surface of the ring shaped member.

17. The ring of claim 16, wherein the first elasticity produces a more flexible ring shaped member than the second elasticity.

18. The ring of claim 14, wherein a sum of lengths of interior circumference arcs between adjacent slits is at least about 2π(R−b2)−G1, wherein R, b2, and G1 respectively denote a radius of the interior wall of a cylinder the ring shaped member will be associated with, an overall width of the ring shaped member, and the predetermined distance range between ends of the ring shaped member.
